(19) United States
(12) Patent Application Publication
(10) Pub. No.: US 2024/0014519 A1
(43) Pub. Date: Jan. 11, 2024

(54) BATTERY

(71) Applicant: Panasonic Intellectual Property Management Co., Ltd., Osaka (JP)

(72) Inventors: Eiichi KOGA, Osaka (JP); Noriyuki UCHIDA, Osaka (JP)

(21) Appl. No.: 18/471,066

(22) Filed: Sep. 20, 2023

Related U.S. Application Data
(63) Continuation of application No. PCT/JP2022/002962, filed on Jan. 26, 2022.

(30) Foreign Application Priority Data
Mar. 24, 2021 (JP) 2021-050429

(51) Int. Cl. H01M 50/533; H01M 50/536; H01M 50/184; H01M 50/193; H01M 50/174; H01M 50/528; H01M 10/0585

(52) U.S. Cl. CPC H01M 50/533; H01M 50/536; H01M 50/184; H01M 50/193; H01M 50/174; H01M 50/528; H01M 10/0585; H01M 2300/0065

(57) ABSTRACT

A battery of the present disclosure includes: a battery element, the battery element including a first electrode, a solid electrolyte layer, and a second electrode; an insulating member; a lead terminal; and a first solder material. The insulating member encloses the battery element and the first solder material. The lead terminal is electrically connected to the battery element. The first solder material is positioned between the insulating member and the lead terminal.

This application is a continuation of PCT/JP2022/002962 filed on Jan. 26, 2022, which claims foreign priority of Japanese Patent Application No. 2021-050429 filed on Mar. 24, 2021, the entire contents of both of which are incorporated herein by reference.

### BACKGROUND OF THE INVENTION

### 1. Field of the Invention

The present disclosure relates to a battery.

### 2. Description of Related Art

JP H04-345749 A discloses a battery obtained through molding in which a battery and a lead terminal are housed in a molded resin. JP 2004-356461 A discloses a battery in which a cell using an electrolyte solution and a lead terminal are housed in a housing formed of an insulating material.

### SUMMARY OF THE INVENTION

The present disclosure aims to provide a battery having a structure suitable for reliability enhancement.

A battery of the present disclosure including:
a battery element, the battery element including a first electrode, a solid electrolyte layer, and a second electrode;
an insulating member;
a lead terminal; and
a first solder material, wherein
the insulating member encloses the battery element and the first solder material,
the lead terminal is electrically connected to the battery element, and
the first solder material is positioned between the insulating member and the lead terminal.

The present disclosure provides a battery having a structure suitable for reliability enhancement.

### BRIEF DESCRIPTION OF THE DRAWINGS

FIG. 1 schematically shows the configuration of a battery 1000 according to Embodiment 1.

FIG. 2 is a cross-sectional view schematically showing the configuration of a battery 1100 in which a first solder material 400 of the battery 1000 according to Embodiment 1 has not molten yet.

FIG. 3 schematically shows the configuration of a battery 1200 according to Embodiment 2.

FIG. 4 schematically shows the configuration of a battery 1300 according to Embodiment 3.

### DETAILED DESCRIPTION

Embodiments of the present disclosure will be specifically described below with reference to the drawings.

The embodiments to be described below each illustrate a generic or specific example. The numerical values, shapes, materials, constituent elements, arrangement positions of the constituent elements, and manners of connection of the constituent elements, etc. which will be indicated in the embodiments below are only illustrative, and are not intended to limit the present disclosure.

In the present specification, terms such as parallel representing the relations between elements, terms such as rectangular parallelepiped representing the shapes of elements, and numerical ranges are not expressions representing only their strict meanings, but are intended to include even substantial equivalents, for example, even variations of about several percentage.

The drawings are not necessarily strict. In the drawings, substantially identical constituent elements are assigned with the same reference numerals, and redundant description thereof will be omitted or simplified.

In the present specification and drawings, the x axis, the y axis, and the z axis indicate the three axes in a three-dimensional orthogonal coordinate system. In the embodiments, the z-axis direction is defined as the thickness direction of the battery. Moreover, in the present specification, the “thickness direction” refers to a direction perpendicular to the plane up to which the layers are laminated in the battery element, unless specifically stated otherwise.

In the present specification, the phrase “in plan view” means that the battery is viewed along the lamination direction in the battery element, unless specifically stated otherwise. In the present specification, the “thickness” refers to the length of the battery element and the layers in the lamination direction.

In the present specification, the terms “upper” and “lower” in the battery configuration respectively do not mean being in the upward direction (vertically above) and being in the downward direction (vertically below) in the absolute spatial recognition, but are used as the terms defined by the relative positional relation based on the lamination order in the lamination structure. Moreover, the terms “upper” and “lower” are applied not only in the case where two constituent elements are disposed in close and direct contact with each other, but also in the case where two constituent elements are disposed with a space therebetween and another constituent element is present between the two constituent elements.

In the present specification, the “side surface” and the “principal surface” of the battery element respectively refer to the surface along the lamination direction and the surface other than the side surface, unless specifically stated otherwise.

In the present specification, “in” and “out” in the terms “inward”, “outward”, and the like respectively indicate the side close to the center of the battery and the side close to the periphery of the battery when the battery is viewed along the lamination direction in the battery element.

### Embodiment 1

The configuration of a battery according to Embodiment 1 will be described below.

The battery according to Embodiment 1 includes: a battery element, the battery element including a first electrode, a solid electrolyte layer, and a second electrode; an insulating member; a lead terminal; and a first solder material. The insulating member encloses the battery element and the first solder material. The lead terminal is electrically connected to the battery element. The first solder material is positioned between the insulating member and the lead terminal. Here, the phrase “the insulating member encloses the battery element and the first solder material” means that the battery element and the first solder material are disposed so as to be embedded in the insulating member, and means that, for example, the battery element and the first solder material are placed inside the insulating member in projection view of the battery in every direction. The term “enclose” in the present specification is hereinafter used to represent the similar meaning.

As described in 2. Description of Related Art, JP H04-345749 A discloses a battery obtained through molding in which a battery and a lead terminal are housed in a molded resin. In the battery disclosed in JP H04-345749 A, unfortunately, a solder material is provided in a mounting portion outside the molded resin. Accordingly, inside the molded resin, no solder material is present between the molded resin and the lead terminal. This can generate a gap serving as the penetration path of moisture and the like between the molded resin and the lead terminal. This leads to a problem of deterioration in characteristics due to long-term use. JP 2004-356461 A discloses a battery in which a cell using an electrolyte solution and a lead terminal are housed in a housing formed of an insulating material. In the battery disclosed in JP 2004-356461 A, unfortunately, no solder material is provided in the lead terminal enclosed with the insulating member, as in JP H04-345749 A. Furthermore, a battery using an electrolyte solution generally has a low heat resistance, which causes difficulty in surface mounting by the reflow and causes a problem with high-temperature reliability. For these reasons, the batteries disclosed in JP H04-345749 A and JP 2004-356461 A have a limited method for mounting surface-mount components, and also restrict the reliability of the entire battery.

In the battery according to Embodiment 1, the first solder material is present between the insulating member and the lead terminal. When the first solder material melts during the heat treatment or solder mounting, the molten and then resolidified first solder material seals gaps between the insulating member and the lead terminal. Consequently, it is possible to prevent moisture and the like from penetrating into the battery through the gaps between the lead terminal and the insulating member. Therefore, the battery according to Embodiment 1 has a structure suitable for reliability enhancement.

The battery according to Embodiment 1 is, for example, a surface-mounted battery.

The battery according to Embodiment 1 may be an all-solid-state battery. In the case where the battery according to Embodiment 1 is an all-solid-state battery, it is possible to melt solder at a temperature too high for an electrolyte solution to resist, thereby achieving the sealing structure. This causes no problem in mounting method and high-temperature reliability.

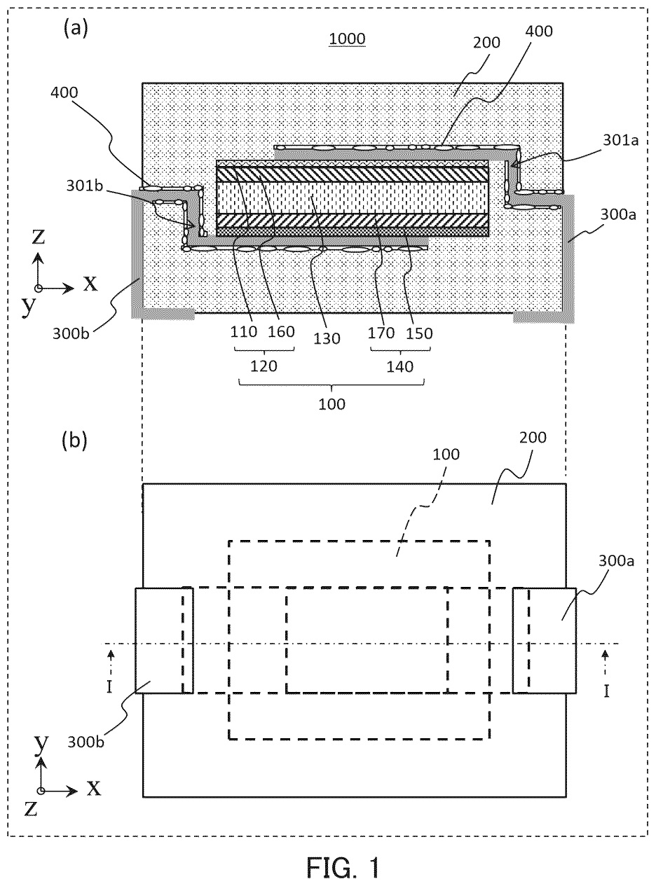

FIG. 1 schematically shows the configuration of a battery 1000 according to Embodiment 1.

FIG. 1(a) is a cross-sectional view schematically showing the configuration of the battery 1000 as viewed in the y-axis direction. FIG. 1(b) is a plan view schematically showing the configuration of the battery 1000 as viewed from below in the z-axis direction. In FIG. 1(a), a cross section at the position indicated by line I-I in FIG. 1(b) is shown.

As shown in FIG. 1, the battery 1000 includes a battery element 100, the battery element 100 including a first electrode 120, a solid electrolyte layer 130, and a second electrode 140; an insulating member 200; a lead terminal 300a; a lead terminal 300b; and a first solder material 400. The battery element 100 includes the first electrode 120, the solid electrolyte layer 130, and the second electrode 140 that are laminated in this order. The first electrode 120 includes a first current collector 110 and a first active material layer 160. The second electrode 140 includes a second current collector 150 and a second active material layer 170. The solid electrolyte layer 130 is positioned between the first active material layer 160 and the second active material layer 170. The lead terminal 300a is electrically connected to the first current collector 110. The lead terminal 300b is electrically connected to the second current collector 150. The lead terminal 300a and the lead terminal 300b are also hereinafter collectively referred to as a lead terminal. The insulating member 200 encloses the battery element 100, the first solder material 400, and portions of the lead terminal 300a and the lead terminal 300b excluding the mounting terminal portions. The mounting terminal portions are exposed to the outside of the insulating member 200 for electrical connection to an external circuit. The first solder material 400 is positioned between the insulating member 200 and the lead terminal.

The battery 1000 is, for example, an all-solid-state battery.

The constituent elements of the battery 1000 will be described below in detail with reference to FIG. 1(a) and FIG. 1(b).

### (Battery Element 100)

The battery element 100 includes the first electrode 120, the solid electrolyte layer 130, and the second electrode 140 that are laminated in this order. The first electrode 120 includes, for example, the first current collector 110 and the first active material layer 160. The second electrode 140 includes, for example, the second current collector 150 and the second active material layer 170. That is, the battery element 100 includes, for example, the first current collector 110, the first active material layer 160, the solid electrolyte layer 130, the second active material layer 170, and the second current collector 150 that are laminated in this order.

The battery element 100 has a principal surface and a side surface.

The battery element 100 is enclosed with the insulating member 200.

The battery element 100 may be in the shape of a rectangular parallelepiped, or may have a different shape. The different shape is, for example, a circular column or a polygonal column.

In the present specification, being in the shape of a rectangular parallelepiped means being roughly in the shape of a rectangular parallelepiped, and includes the concept of being in the shape of a chamfered rectangular parallelepiped. The same applies to other shape expressions in the present specification.

In the first electrode 120, another layer such as a joining layer formed of an electrically conductive material may be provided between the first current collector 110 and the first active material layer 160.

In the second electrode 140, another layer such as a joining layer formed of an electrically conductive material may be provided between the second current collector 150 and the second active material layer 170.

The first electrode 120 may not include the first current collector 110. That is, the first electrode 120 may consist of the first active material layer 160. In this case, the second current collector 150, an electrode different from the first electrode 120 and the second electrode 140, a board supporting the battery 1000, or the like may be used to collect electricity from the first electrode 120. Similarly, the second electrode 140 may not include the second current collector 150. That is, the second electrode 140 may consist of the second active material layer 170.

The first electrode 120 may be a positive electrode. In this case, the first active material layer 160 is a positive electrode active material layer.

The second electrode 140 may be a negative electrode. In this case, the second active material layer 170 is a negative electrode active material layer.

The first electrode 120 and the second electrode 140 are also hereinafter referred to simply as “electrodes”. Moreover, the first current collector 110 and the second current collector 150 are also referred to simply as “current collectors”.

The positive electrode active material layer contains a positive electrode active material. The positive electrode active material refers to a material that intercalates or deintercalates metal ions, such as lithium (Li) ions or magnesium (Mg) ions, in the crystal structure at a higher potential than the potential of the negative electrode and is accordingly oxidized or reduced. The positive electrode active material can be selected as appropriate depending on the battery type, and a known positive electrode active material can be used. In the case where the battery element 100 is, for example, a lithium secondary battery, the positive electrode active material is a material that intercalates or deintercalates lithium (Li) ions and is accordingly oxidized or reduced. In this case, the positive electrode active material is, for example, a compound containing lithium and a transition metal element, more specifically, an oxide containing lithium and a transition metal element, a phosphate compound containing lithium and a transition metal element, or the like. Examples of the oxide containing lithium and a transition metal element include a lithium nickel composite oxide, such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), a layered oxide, such as lithium cobalt oxide (LiCoO₂), lithium nickel oxide (LiNiO₂), and lithium manganese oxide (LiMn₂O₄), and lithium manganese oxide (LiMn₂O₄, Li₂MnO₃, and LiMnO₂) having a spinel structure. Examples of the phosphate compound containing lithium and a transition metal element include lithium iron phosphate (LiFePO₄) having an olivine structure. Moreover, sulfur (S) or a sulfide, such as lithium sulfide (Li₂S), can also be used for the positive electrode active material. In this case, positive electrode active material particles which are coated with lithium niobate (LiNbO₃) or the like or to which lithium niobate (LiNbO₃) or the like is added can be used as the positive electrode active material. The positive electrode active material may be only one of these materials or a combination of two or more of the materials.

The positive electrode active material layer, which contains the positive electrode active material, may contain a different additive material. That is, the positive electrode active material layer may be a mixture layer. The additive material can be, for example, a solid electrolyte, such as a solid inorganic electrolyte or a solid sulfide electrolyte, an electrically conductive additive, such as acetylene black, or a binder, such as polyethylene oxide or polyvinylidene fluoride. By mixing the positive electrode active material with the different additive material, such as a solid electrolyte or an electrically conductive additive, in a predetermined proportion, it is possible to enhance the ionic conductivity inside the positive electrode and enhance the electron conductivity inside the positive electrode as well. The solid electrolyte can be, for example, a solid electrolyte exemplified as the material of the solid electrolyte layer 130 described later.

The positive electrode active material layer may have a thickness of, for example, 5 μm or more and 300 μm or less.

The negative electrode active material layer contains a negative electrode active material. The negative electrode active material refers to a material that intercalates or deintercalates metal ions, such as lithium (Li) ions or magnesium (Mg) ions, in the crystal structure at a lower potential than the potential of the positive electrode and is accordingly oxidized or reduced. The negative electrode active material can be selected as appropriate depending on the battery type, and a known negative electrode active material can be used. The negative electrode active material can be, for example, a carbon material, such as natural graphite, artificial graphite, a graphite carbon fiber, or resin baked carbon, or an alloy-based material to be mixed with a solid electrolyte. The alloy-based material can be, for example, a lithium alloy, such as LiAl, LiZn, Li₃Bi, Li₃Cd, Li₃Sb, LiaSi, Li_{4.4}Pb, Li_{4.4}Sn, Li_{0.17}C, or LiC₆, an oxide of lithium and a transition metal element, such as lithium titanate (Li₄Ti₅O₁₂), or a metal oxide, such as zinc oxide (ZnO) or silicon oxide (SiOₓ). The negative electrode active material may be only one of these materials or a combination of two or more of the materials.

The negative electrode active material layer, which contains the negative electrode active material, may contain a different additive material. That is, the negative electrode active material layer may be a mixture layer. The additive material can be, for example, a solid electrolyte, such as a solid inorganic electrolyte or a solid sulfide electrolyte, an electrically conductive additive, such as acetylene black, or a binder, such as polyethylene oxide or polyvinylidene fluoride. By mixing the negative electrode active material with the different additive material, such as a solid electrolyte or an electrically conductive additive, in a predetermined proportion, it is possible to enhance the ionic conductivity inside the negative electrode and enhance the electron conductivity inside the negative electrode as well. The solid electrolyte can be, for example, a solid electrolyte exemplified as the material of the solid electrolyte layer 130 described later.

The negative electrode active material layer may have a thickness of, for example, 5 μm or more and 300 μm or less.

The current collectors should be formed of any electrically conductive material, and are not limited to any particular material. The current collectors are each, for example, a foil-like, plate-like, or mesh-like current collector formed of, for example, stainless steel, nickel, aluminum, iron, titanium, copper, palladium, gold, or platinum, or an alloy of two or more of these metals. The material of the current collectors should be selected as appropriate in view of: neither melting nor decomposition in the manufacturing process, at the operating temperature, and at the operating pressure; the battery operation potential applied to the current collectors; and the electrical conductivity. Moreover, the material of the current collectors can be selected also depending on the required tensile strength and heat resistance. The current collectors each may be a high-strength electrolytic copper foil or a cladding material composed of laminated dissimilar metal foils.

The current collectors each may have a thickness of, for example, 10 μm or more and 100 μm or less.

The solid electrolyte layer 130 is positioned between the first electrode 120 and the second electrode 140. The solid electrolyte layer 130 may be in contact with the lower surface of the first electrode 120 and the upper surface of the second electrode 140. That is, no other layer may be provided between the solid electrolyte layer 130 and each of the electrodes.

The solid electrolyte layer 130 may not be in contact with the lower surface of the first electrode 120 and the upper surface of the second electrode 140.

The solid electrolyte layer 130 may be in contact with the respective side surfaces of the first electrode 120 and the second electrode 140, the lower surface of the first electrode 120, and the upper surface of the second electrode 140 so as to coat the respective side surfaces of the first electrode 120 and the second electrode 140.

The solid electrolyte layer 130 contains a solid electrolyte. The solid electrolyte layer 130 should contain any known ionic conductive solid electrolyte for batteries. For example, a solid electrolyte that conducts metal ions, such as lithium ions and magnesium ions, can be used. The solid electrolyte should be selected as appropriate depending on the conductive ionic species. For example, a solid inorganic electrolyte, such as a solid sulfide electrolyte or a solid oxide electrolyte, can be used. Examples of the solid sulfide electrolyte include lithium-containing sulfides, such as those based on Li₂S—P₂S₅, Li₂S—SiS₂, Li₂S—B₂S₃, Li₂S—GeS₂, Li₂S—SiS₂—LiI, Li₂S—SiS₂—Li₃PO₄, Li₂S—Ge₂S₂, Li₂S—GeS₂—P₂S₅, and Li₂S—GeS₂—ZnS. Examples of the solid oxide electrolyte include a lithium-containing metal oxide, such as Li₂O—SiO₂ and Li₂O—SiO₂—P₂O₅, a lithium-containing metal nitride, such as LiₓP_{y}O_{1-z}N_{z} (0<z≤1), lithium phosphate (Li₃PO₄), and a lithium-containing transition metal oxide, such as lithium titanium oxide. The solid electrolyte may be only one of these materials or a combination of two or more of the materials.

The solid electrolyte layer 130, which contains the solid electrolyte, may contain, for example, a binder, such as polyethylene oxide or polyvinylidene fluoride.

The solid electrolyte layer 130 may have a thickness of, for example, 5 μm or more and 150 μm or less.

The solid electrolyte layer 130 may be constituted of an aggregate of particles of the solid electrolyte. The solid electrolyte layer 130 may be constituted of a sintered structure of the solid electrolyte.

### (Insulating Member 200)

The insulating member 200 is an exterior material that houses the battery element 100. The insulating member 200 encloses the battery element 100, a portion of the lead terminal, and the first solder material 400. The portion of the lead terminal that is not enclosed with the insulating member 200 is exposed from the insulating member 200 to serve as, for example, the mounting terminal portion.

The material of the insulating member 200 should be any electrical insulator. The insulating member 200 should be formed of any insulating material that has no influence on the battery characteristics. The insulating member 200 may include a resin. The resin may be a thermosetting resin or a thermoplastic resin. The resin may be a thermosetting resin. The resin may be a thermosetting resin having a curing temperature lower than the melting point of the first solder material 400. Examples of the resin include an epoxy resin, an acrylic resin, a polyimide resin, and silsesquioxane. The material of the insulating member 200 may be, for example, an applicable resin such as a liquid or powdery thermosetting epoxy resin. Such an applicable resin in a liquid or powdery state is applied as the exterior body of the battery 1000 for thermal curing, so that integral formation of a miniature battery can be achieved. Thus, the reliability of the battery can be enhanced. The insulating member 200 may include an epoxy resin.

The insulating member 200 may be formed of an epoxy resin. Since epoxy resins are resistant to heat having a temperature equal to or higher than the melting point of a general solder material, gaps between the insulating member 200 and the lead terminal can be sealed by melting the first solder material 400. Consequently, a highly reliable surface-mounted battery can be achieved.

The insulating member 200 may be, for example, softer than any constituent member of the battery element 100, specifically, the first electrode 120, the solid electrolyte layer 130, and the second electrode 140. In this case, the insulating member 200, which is relatively soft, can absorb the stress generated between the insulating member 200 and the constituent members. Consequently, it is possible to suppress the occurrence of a structural defect of the battery 1000 such as cracking in the sealing structure formed by the first solder material 400 described later or separation of the current collectors.

The insulating member 200 may have a Young's modulus of 10 GPa or more and 40 GPa or less. For example, an epoxy resin having a Young's modulus in such a range may be used for the insulating member 200. In this case, it is possible to enhance the reliability of the battery 1000.

The hardness (i.e., extent of curing) of the insulating member 200 can be adjusted by the selection of the curing temperature and the curing time. The hardness of the insulating member 200 can be increased, for example, by increasing the curing temperature, extending the curing time, or increasing the number of times of the curing process for the insulating member 200. Moreover, the hardness can be adjusted also by enclosing voids with the insulating member 200. As described above, even with use of the same insulating material, the hardness can be controlled according to the thermal history determined by the selection of the curing conditions and the manufacturing process.

It is possible to make a comparison on the relative relation in softness (e.g., elastic modulus such as Young's modulus) between the constituent members of the battery element 100 and the insulating member 200, by applying a rigid indenter and comparing the magnitude relation in size of the indentation between the constituent members of the battery element 100 and the insulating member 200 as in Vickers hardness measurement. For example, the indenter is pressed against portions of the cross section of the battery 1000 with the same force. In the case where the insulating member 200 becomes recessed more greatly than any constituent member of the battery element 100, the insulating member 200 can be regarded as softer than any constituent member of the battery element 100.

### (Lead Terminals 300a and 300b)

The lead terminal is electrically connected to the current collectors included in the electrodes.

To connect the lead terminal to the current collectors, a highly electrically conductive adhesive containing electrically conductive metal particles such as Ag particles, solder, or the like may be used. To connect the lead terminal to the current collectors, the material having the same composition as the first solder material 400 may be used. Alternatively, various known electrically conductive resins containing Cu, Al, or the like, or electrically conductive materials containing lead-free, lead-based, gold-tin-based, or other solder may be used. Further alternatively, an electrically conductive tape may be used. The material for connecting the lead terminal to the current collectors may have a curing temperature (melting point) lower than the melting point of the first solder material 400.

Inside the insulating member 200, the lead terminal may be in the shape of a flat plate. The lead terminal may be composed of, for example, a flat plate-shaped portion and a bent portion. The bent portion may be formed, for example, by bending the lead terminal that is in the shape of a flat plate. In the case where the lead terminal has the bent portion, it is possible to further suppress penetration of air and moisture into the battery through the gaps between the lead terminal and the insulating member 200. Furthermore, in the case where the lead terminal has the bent portion, the molten first solder material 400 tends to gather in the bent portion. Accordingly, when melting and then becoming cooled to solidify, the first solder material 400 closes and seals the gaps between the insulating member 200 and the lead terminal in the bent portion. This further suppresses penetration of moisture and the like.

Inside the insulating member 200, the lead terminals 300a and 300b each have the two bent portions that are each bent at 90°. The lead terminals 300a and 300b each have the two bent portions that are each bent at 90° in contact with the surface of the insulating member 200. However, the angle, number, and arrangement of the bent portions are not limited to these. For example, the angle of the bent portion may be 10° to 90°, and the number of the bent portions may be one to three. To suppress penetration of moisture and the like, the lead terminals 300a and 300b each may have the two or more bent portions enclosed with the insulating member 200.

The lead terminal 300a connected to the first current collector 110 may extend along the principal surface of the first current collector 110 of the battery element 100 and then be bent toward a direction along the side surface of the battery element 100. The lead terminal 300b connected to the second current collector 150 may extend along the principal surface of the second current collector 150 of the battery element 100 and then be bent toward the direction along the side surface of the battery element 100. In this way, the lead terminal may be bent toward the direction along the side surface of the battery element 100. That is, the lead terminal may have a portion along the side surface of the battery element 100.

The bent portion of the lead terminal 300a connected to the principal surface of the first current collector 110 may have a crank-shaped bent portion 301a. The crank-shaped bent portion 301a extends along the principal surface of the first current collector 110 of the battery element 100, and then is bent toward the direction along the side surface of the battery element 100 and is bent to extend toward the outside of the insulating member 200. The bent portion of the lead terminal 300b connected to the principal surface of the second current collector 150 may have a crank-shaped bent portion 301b. The crank-shaped bent portion 301b extends along the principal surface of the second current collector 150 of the battery element 100, and then is bent toward the direction along the side surface of the battery element 100 and is bent to extend toward the outside of the insulating member 200.

In the case where the lead terminal has the bent portion 301a and the bent portion 301b, it is possible to further suppress penetration of air and moisture into the battery through the gaps between the lead terminal and the insulating member 200.

The first solder material 400 may be positioned between the bent portion 301a and the insulating member 200, and may be positioned between the bent portion 301b and the insulating member 200. In this case, when melting and then becoming cooled to solidify, the first solder material 400 closes and seals the gaps between the insulating member 200 and the lead terminal in the bent portion 301a and the bent portion 301b. This further suppresses penetration of moisture and the like.

The first solder material 400 may be in contact with the bent portion. In this case, the molten first solder material 400 solidifies in the bent portion to close the gaps, thereby enhancing the sealing properties to further suppress penetration of moisture and the like. The first solder material 400 may be in contact with the bent portion 301a, and may be in contact with the bent portion 301b. In each of the bent portions 301a and 301b, the first solder material 400 may form a sealing portion that seals the gaps between the lead terminal and the insulating member 200. The sealing portion may be formed in a portion other than the bent portion.

The lead terminal may have an outside portion, and the outside portion is positioned outside the outer periphery of the battery element 100 in plan view. The first solder material 400 may be present between the outside portion and the insulating member 200.

The first solder material 400 may be in contact with the above outside portion of the lead terminal.

The portion of the lead terminal may be exposed on the surface of the battery 1000. The exposed portion of the lead terminal, on the surface of the battery 1000, may be disposed along the side surface of the battery 1000 and furthermore bent inward again on the bottom surface of the battery 1000 so that the exposed portion of the lead terminal constitutes a joining portion for the mounting board. In this case, the lead terminal includes the mounting terminal portion.

The material of the lead terminal can be general stainless steel (SUS), phosphor bronze, or the like. The material of the lead terminal should be any electrical conductor having solder wettability such as stainless steel, iron, or copper. An alloy or a clad material can be used as well. In view of assembling and processing efficiency, mounting efficiency, durability to vibration or the thermal cycling test, etc., another conductor may be used as appropriate depending on the application.

The width of the lead terminal may be adjusted as appropriate according to the size of the battery element 100 or the land pattern of the mounting board. The width of the lead terminal may be smaller than the width of the battery element 100. In this case, the outer periphery of the battery element 100 can be used as positioning. Moreover, a reduction in heat capacity of the lead terminal can enhance the productivity in the heat treatment process.

The lead terminals 300a and 300b shown in FIG. 1 are each in the shape of a rectangular flat plate. However, the shape of the lead terminal is not limited to this. For example, the lead terminal may be partially small in width.

The lead terminal may have a thickness of 200 μm or more and 1000 μm or less.

To support the high electric current and to enhance the fixing strength, the lead terminal may be further increased in width, and may be further increased in thickness.

Inside the insulating member 200, the lead terminal may have a hole. In this case, it is possible to further enhance the sealing properties between the insulating member 200 and the lead terminal.

The shape of the hole is not limited. The hole has, for example, a circular shape or a rectangular shape. The number of the holes may be one, or may be more than one. The number of the holes should be within a range by which any problem in assembling, strength, etc. is not caused.

The hole is formed, for example, by punching the lead terminal with a die or by etching. Providing the hole reduces the heat capacity of the lead terminal, thereby enhancing the responsiveness of solder to melting during the heat treatment to achieve the sealing properties in a short time. Consequently, the productivity is enhanced as well. Moreover, an anchor effect between the lead terminal and the insulating member 200 is also achieved, and accordingly the fixing properties are enhanced as well.

The mounting terminal portion may have a surface containing a solder component. For example, the surface may be coated by Sn plating, with a Sn-based solder paste, or by solder dip coating. In this case, it is possible to adopt the reflow by a general mounting method for industrial use, thereby enabling mounting on boards simultaneously with other surface-mount components. This enhances the productivity in mounting on boards. Moreover, an improvement in solder wettability of the mounting terminal portion enhances the fixing properties between the board and the mounting terminal portion. This enhances the reliability in practical use. The layer containing the solder component formed by the coating may have a thickness of 1 μm or more and 10 μm or less.

The battery 1000 according to Embodiment 1 may further include a water-repellent material, and the water-repellent material may be in contact with the lead terminal.

### (First Solder Material 400)

The first solder material 400 is positioned between the insulating member 200 and the lead terminal. The first solder material 400 may be in contact with both the insulating member 200 and the lead terminal.

The first solder material 400 can be a general solder material for use in mounting. The first solder material 400 should be any solder material that melts by the heat treatment. The first solder material 400 should be any solder material that has no adverse influence on the battery element 100 and the insulating member 200 during the heat treatment. The first solder material 400 may be a lead-free solder material. An example of the solder material is a Sn-based solder material. Examples of the Sn-based solder material include those based on Sn—Sb, Sn—Cu, Sn—Ag, Sn—Cu—Ag, Sn—Zn, Sn—Zn—Bi, and Sn—In. Alternatively, the first solder material 400 may be a lead-based solder material that has been conventionally used widely. An example of the lead-based solder material is a Sn—Pb-based solder material. When melting, a lead-free solder material, which exhibits poor wettability, generally tends to become scattered on the lead terminal in the form of an island without spreading over the entire lead terminal. Accordingly, the portion of the first solder material 400 in which the height is increased (the apex portion of the island-like first solder material 400) is facilitated to exhibit a further enhanced action of sealing the gaps between the insulating member 200 and the lead terminal.

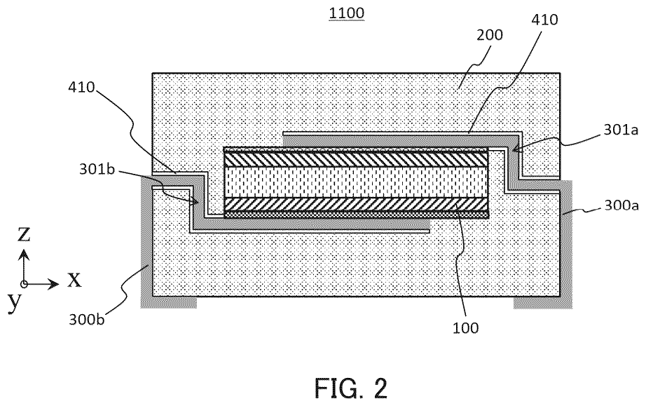

The first solder material 400 shown in FIG. 1(a) is obtained by melting a solder material through a heat treatment and then resolidifying the solder material that is scattered in the form of an island. However, the form of the first solder material in the battery according to Embodiment 1 is not limited to this. In the battery according to Embodiment 1, the first solder material may include a solder film provided on the surface of the lead terminal, and the first solder material may be formed of a solder film provided on the surface of the lead terminal. A battery including such a solder film is obtained, for example, by enclosing, with the insulating member 200, the battery element 100 and the lead terminal whose surface has the solder film in advance provided thereon and then performing no heat treatment. FIG. 2 is a cross-sectional view schematically showing the configuration of a battery 1100 in which the first solder material 400 of the battery 1000 according to Embodiment 1 has not molten yet. As shown in FIG. 2, the battery 1100 includes the first solder material in the form of a solder film 410 provided between the lead terminal and the insulating member 200. The solder film 410 may be a solder plating film coating the surface of the lead terminal. An example in which the solder film 410 is a solder plating film will be described below. Accordingly, the solder film 410 is hereinafter referred to as a solder plating film 410.

The battery 1100 is, for example, heat-treated at a temperature equal to or higher than the melting point of the solder plating film 410. This heat treatment melts the solder plating film 410 and thus to, for example, form the island-like first solder material 400 as shown in FIG. 1(a). That is, the first solder material 400 becomes scattered in the form of an island in a discontinuous manner. Consequently, the scattered portions of the first solder material 400 thus formed have portions having a larger thickness than the solder plating film 410 before melting. The first solder material 400 thus formed becomes cooled to solidify, so that portions filling the gaps between the insulating member 200 and the lead terminal are formed throughout the first solder material 400. Consequently, the gaps between the lead terminal and the insulating member 200 are closed with the first solder material 400. Consequently, it is possible to prevent penetration of moisture and the like into the battery through the gaps between the insulating member 200 and the lead terminal. Thus, in the case where the battery 1100 is heat-treated at a temperature equal to or higher than the melting point of the solder material, it is possible to prevent penetration of moisture and the like into the battery. Therefore, the battery 1100 has a structure suitable for enhancing the reliability of the battery. A general solder material has a coefficient of linear expansion of about +20 ppm/° C., whereas a general insulating material (e.g., an epoxy resin-based material) for use as the insulating member 200 has a coefficient of linear expansion of about +5 ppm/° C. Accordingly, at a high temperature in the thermal cycle, the apex portion of the island-like first solder material 400 sometimes presses into the wall surface of the insulating member 200. However, the difference in thermal expansion can be absorbed by using, as the material of the insulating member 200, a material that is softer than both the first solder material 400 and the material of the lead terminal. An epoxy resin and the like, which are soft over a range from a low temperature to a high temperature (e.g., the operating temperature range from −25° C. to are suitable as the insulating member 200. This achieves high sealing properties without causing a structural defect even in the thermal cycle. Therefore, the battery according to Embodiment 1 has a structure suitable for reliability enhancement.

The form of the first solder material 400 is not limited. The first solder material 400 may be in the form of an island (be island-like), and the first solder material 400 may be in the form of an island so as to have a width of 10 μm or more and 1000 μm or less. In this case, it is possible to close the gaps between the insulating member 200 and the lead terminal with a plurality of portions of the molten first solder material 400. The plurality of portions have thicknesses increased by the surface tension. The first solder material 400 shown in FIG. 1(a) is in the form of an island. Alternatively, the first solder material 400 may include a filmy solder material. That is, the first solder material 400 may not be entirely in the form of an island so as to be partially filmy. The first solder material 400 having such a structure fills the gaps between the insulating member 200 and the lead terminal and thus to close the gaps between the insulating member 200 and the lead terminal.

The first solder material 400 may close at least a portion of the gaps between the insulating member 200 and the lead terminal. In this case, it is possible to prevent penetration of moisture and the like into the battery through the gaps between the insulating member 200 and the lead terminal, thereby enhancing the reliability of the battery.

The space formed by the first solder material 400 closing and sealing the gaps between the insulating member 200 and the lead terminal may be filled with a gas such as air. The gas may be nitrogen gas or argon gas. The gas should be any gas that has no adverse influence of the characteristics of the battery element 100 and the insulating member 200. Using a dry gas achieves even an anticorrosive effect of the lead terminal.

The position of the first solder material 400 is not limited. The first solder material 400 may be positioned between the bent portion of the lead terminal and the insulating member 200, and may be in contact with both the bent portion of the lead terminal and the insulating member 200. As described above, the first solder material 400 may be positioned between the bent portion 301a or 301b of the lead terminal and the insulating member 200, and may be in contact with both the bent portion 301a or 301b of the lead terminal and the insulating member 200. The first solder material 400 may be in contact with the bent portion 301a or 301b of the lead terminal. In the case where the first solder material 400 solidifies in the bent portion 301a or 301b, the path through which moisture and the like can penetrate becomes complicated and thus to be easily closed with the first solder material 400. Consequently, it is possible to further prevent penetration of moisture and the like into the battery. The first solder material 400 may be positioned between the battery element 100 and the lead terminal. The battery element 100 and the lead terminal may be joined to each other with the first solder material 400.

In the case where the first solder material 400 is in the form of an island, the number of the first solder materials 400 is not limited. The number may be one, or may be more than one.

The first solder material 400 positioned between the lead terminal 300a and the insulating member 200 and the first solder material 400 positioned between the lead terminal 300b and the insulating member 200 may not be symmetrical in terms of form and number. For example, the first solder material 400 may be either positioned between the lead terminal 300a and the insulating member 200 or positioned between the lead terminal 300b and the insulating member 200.

The first solder material 400 can be confirmed by a cross-sectional observation method with a general optical microscope or scanning electron microscope (SEM). Moreover, the first solder material 400 can be observed also by non-destructive analysis such as CT scanning. Furthermore, the sealing properties of the first solder material 400 can be determined by checking, for example, through liquid immersion aging or vacuum suction, whether penetration into the internal structure has occurred.

The first solder material 400 may include a fluxing material.

The fluxing material is positioned, for example, between the insulating member 200 and the first solder material 400. Consequently, it is possible to perform a wide-range control of the solder wettability exhibited by the first solder material 400 and exhibited on the surface of the lead terminal, thereby adjusting the sealed state of the gaps between the insulating member 200 and the lead terminal. Therefore, the reliability of the battery can be further enhanced.

The fluxing material can be, for example, a fluxing material that is often used for solder mounting, such as a resin-based fluxing material, including rosin-based fluxing material and a synthetic resin-based fluxing material, an organic acid-based fluxing material, or an inorganic acid-based fluxing material.

The wettability and the molten state of the solder that are suitable for achieving the sealing properties can be adjusted according to the combination of the atmosphere of the heat treatment (e.g., a nitrogen atmosphere), the first solder material 400, and the fluxing material.

The solder plating film 410 may coat the lead terminal so as to have a thickness of, for example, 1 μm or more and 7 μm or less. In the battery mounting by using the lead terminal plated in advance with Sn during the battery assembly, the sealing properties of the first solder material 400 may be achieved through melting and resolidification of the Sn plating.

The solder plating film 410 may coat a portion of the surface of the lead terminal. The solder plating film 410 may be present also between the lead terminal and the battery element 100. The solder plating film 410 may coat the surface of the lead terminal excluding the portion to be joined to the battery element 100.

The solder plating film 410 may be positioned between the bent portion 301a of the lead terminal and the insulating member 200 and between the bent portion 301b of the lead terminal and the insulating member 200. The solder plating film 410 may coat the bent portions 301a and 301b of the lead terminal. In the case where the solder plating film 410 melts in the bent portion 301a or 301b, the path through which moisture and the like can penetrate becomes complicated and thus to be easily sealed with the first solder material 400. Consequently, it is possible to further prevent penetration of moisture and the like into the battery.

In the battery 1100, the solder plating film 410 may be positioned also on the surface of the exposed portion of the lead terminal exposed from the insulating member 200. The solder plating film 410 may be positioned on the mounting terminal portion. The solder plating film 410 may coat the entire lead terminal.

In FIG. 2, the battery 1100 is assembled, for example, by using the lead terminal whose surface is coated with the solder plating film 410 that is a plating film formed of a solder material. Alternatively, the battery 1100 may be assembled by using a lead terminal whose surface is coated with a coating film formed of a solder material. That is, the solder material may be formed between the lead terminal and the insulating member 200 by application such as printing. The solder material may be a solder paste. The solder material may be a Sn—Sb-based solder material. The coating film formed of the solder material may have a thickness of 5 μm or more and 10 μm or less. The sealing properties of the first solder material 400 may be achieved through melting and resolidification of the solder paste.

The battery 1000 may further include a second solder material coating at least a portion of the surface of the exposed portion of the lead terminal exposed from the insulating member 200. The second solder material may coat the mounting terminal portion.

The second solder material may be the same material as the first solder material 400. The second solder material and the first solder material 400 may be continuously formed of the same material.

To adjust the solder wettability so as to meet the mounting application and conditions, a fluxing material can also be applied to the mounting terminal portion of the lead terminal. According to such a configuration, it is possible to adopt the reflow for the battery having enhanced reliability, thereby enabling mounting on boards as in other general surface-mount components represented by multilayer ceramic capacitors (MLCCs). This has high industrial use value.

### Embodiment 2

A battery 1200 according to Embodiment 2 will be described below.

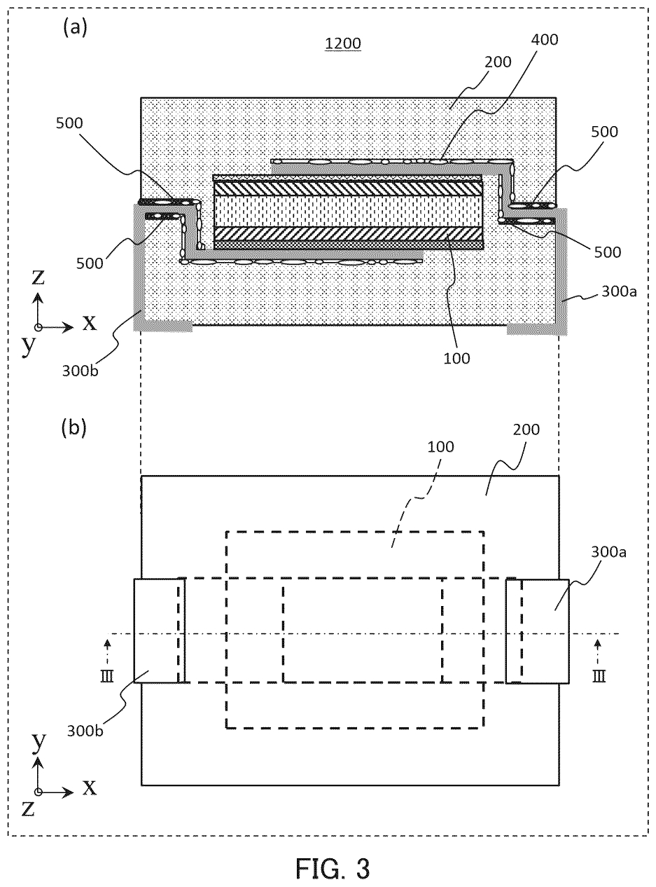

FIG. 3 schematically shows the configuration of the battery 1200 according to Embodiment 2. FIG. 3(a) is a schematic cross-sectional view showing the configuration of the battery 1200 according to Embodiment 2 as viewed in the y-axis direction. FIG. 3(b) is a schematic plan view showing the configuration of the battery 1200 according to Embodiment 2 as viewed from below in the z-axis direction. In FIG. 3(a), a cross section at the position indicated by line III-III in FIG. 3(b) is shown.

The battery 1200 is different from the battery 1000 in that the battery 1200 includes a sealing material 500. The sealing material 500 is positioned between the insulating member 200 and the lead terminal.

According to the above configuration, in the case where gaps are generated by the difference in thermal expansion of the thermal cycle between the insulating member 200 and the first solder material 400 at the interface sealed with solder, namely, at the interface between the insulating member 200 and the first solder material 400, the sealed state can be maintained by sealing the gaps by elastic deformation of the sealing material 500. Therefore, the battery 1200 according to Embodiment 2 has enhanced reliability in the thermal cycle and the flexural stress.

The position of the sealing material 500 is not limited, provided that the position is on the path from the outside of the insulating member 200 to the battery element 100 between the insulating member 200 and the lead terminal.

In the case where the insulating member 200 and the lead terminal have therebetween gaps through which the sealing material can penetrate, filling with the sealing material 500 can be performed, for example, by applying a silicone-based or other sealing material with a dispenser onto the surroundings of the exposed portion of the lead terminal exposed from the insulating member 200 and performing vacuum suction and thus to inject the sealing material deep into the insulating member 200, which is the exterior material of the battery (e.g., into the battery element 100). According to such a method, the sealing material can be injected into even, for example, a gap of 1 μm to 100 μm. The vacuum suction may be repeatedly performed. In this case, it is also possible to increase the integrity of the seal.

The sealing material 500 to be used is a known sealing material such as one based on silicone, polysulfide, acrylic urethane, polyurethane, acrylic, or butyl rubber.

For example, by using a silicone-based sealing material, for example, having resistance to heat at 250° C. to 300° C., it is also possible to perform surface mounting by the reflow or the like. According to such a configuration, it is possible to obtain a battery that can be sealed against the outside air and moisture and has enhanced reliability.

The battery 1200 may include a water-repellent material in addition to the sealing material 500. As with the sealing material 500, the water-repellent material may be positioned between the insulating member 200 and the lead terminal. The water-repellent material may be in contact with the lead terminal. In this case, moisture is repelled on the surface of the lead terminal and the surfaces of minute voids on the insulating member 200 and thus to suppress deterioration due to moisture penetration, so that the reliability of the battery can be further enhanced.

The water-repellent material may be a silane coupling agent.

The silane coupling agent may be applied onto the lead terminal in advance for assembly. The silane coupling agent is effective especially for suppressing moisture penetration into the battery through a minute gap of 1 μm or less.

The silane coupling agent should be any general one. For example, a known silane coupling agent is used, such as one based on methoxy, ethoxy, dialkoxy, or trialkoxy. The silane coupling agent should be any one exhibiting a water-repellent effect on the surfaces of the lead terminal to be used and the insulating member 200.

### Embodiment 3

A battery 1300 according to Embodiment 3 will be described below.

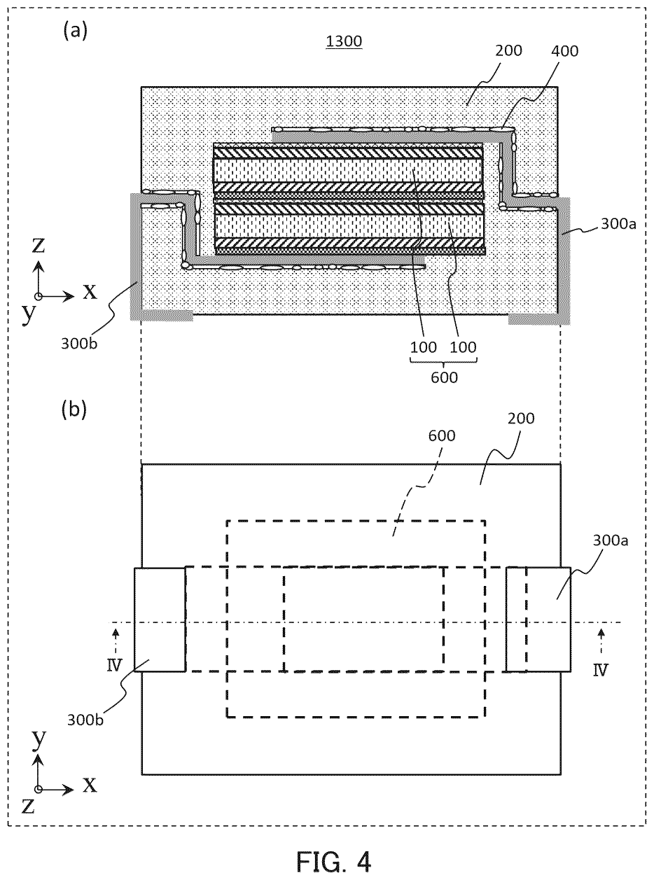

FIG. 4 schematically shows the configuration of the battery 1300 according to Embodiment 3. FIG. 4(a) is a schematic cross-sectional view showing the configuration of the battery 1300 according to Embodiment 3 as viewed in the y-axis direction. FIG. 4(b) is a schematic plan view showing the configuration of the battery 1300 according to Embodiment 3 as viewed from below in the z-axis direction. In FIG. 4(a), a cross section at the position indicated by line IV-IV in FIG. 4(b) is shown.

As shown in FIG. 4, the battery 1300 according to Embodiment 3 includes a battery element 600. The battery element 600 includes the plurality of battery elements 100 that are laminated.

The plurality of battery elements 100 include the opposing electrodes that are electrically connected to each other. This constitutes a bipolar electrode in the battery 1300.

The plurality of battery elements 100 are, for example, adhered to each other with an electrically conductive adhesive or the like.

The electrically conductive adhesive may be a thermosetting electrically conductive paste. The thermosetting electrically conductive paste is, for example, a thermosetting electrically conductive paste containing silver metal particles. The resin to be used for the thermosetting electrically conductive paste should be any resin functioning as the binder. Furthermore, an appropriate resin with suitable printing performance, application performance, or the like may be selected depending on the manufacturing process to be employed. The resin to be used for the thermosetting electrically conductive paste includes, for example, a thermosetting resin. Examples of the thermosetting resin include (i) an amino resin, such as urea resin, melamine resin, and guanamine resin, (ii) an epoxy resin, such as bisphenol A epoxy resin, bisphenol F epoxy resin, phenol novolac epoxy resin, and alicyclic epoxy resin, (iii) an oxetane resin, (iv) a phenolic resin, such as resol phenolic resin and novolac phenolic resin, and (v) a silicone-modified organic resin, such as silicone epoxy resin and silicone polyester resin. The resin may be only one of these materials or a combination of two or more of the materials.

The battery element 600 may include the two battery elements 100 that are laminated in series in the z-axis direction. Alternatively, the battery element 600 may include the three or more battery elements 100 that are laminated.

The plurality of battery elements 100 may be laminated so as to be electrically connected in parallel. In this case, a laminated battery having a high capacity and high reliability can be achieved.

### [Method for Manufacturing Battery]

A method for manufacturing the battery of the present disclosure will be described. A method for manufacturing the battery 1300 according to Embodiment 3 will be described below as an example.

In the following description of the manufacturing method, the first electrode 120 is the positive electrode, and the second electrode 140 is the negative electrode. Accordingly, the first current collector 110 is the positive electrode current collector, and the second current collector 150 is the negative electrode current collector. The battery element 600 includes the two battery elements 100 that are laminated in series.

First, pastes are produced that are to be used for forming the first active material layer 160 (hereinafter, referred to as a positive electrode active material layer) and the second active material layer 170 (hereinafter, referred to as a negative electrode active material layer) by printing. A solid electrolyte raw material to be prepared for use as a mixture of each of the positive electrode active material layer and the negative electrode active material layer is, for example, a Li₂S—P₂S₅-based sulfide glass powder having an average particle diameter of about 10 μm and containing triclinic crystals as its main component. The glass powder has a high ionic conductivity in, for example, an approximate range of 2×10⁻³ S/cm to 3×10⁻³ S/cm. The positive electrode active material to be used is, for example, a Li·Ni·Co·Al composite oxide (e.g., LiNi_{0.8}Co_{0.15}Al_{0.05}O₂) powder having an average particle diameter of about 5 μm and a layered structure. A mixture containing the above positive electrode active material and the above glass powder is dispersed in an organic solvent or the like to produce a positive electrode active material layer paste. The negative electrode active material to be used is, for example, a natural graphite powder having an average particle diameter of about 10 μm. A mixture containing the above negative electrode active material and the above glass powder is dispersed in an organic solvent or the like to produce a negative electrode active material layer paste.

Subsequently, the first current collector 110 (hereinafter, referred to as a positive electrode current collector) and the second current collector 150 (hereinafter, referred to as a negative electrode current collector) to be prepared are each, for example, a copper foil having a thickness of about 15 μm. The above positive electrode active material layer paste and negative electrode active material layer paste are each printed on one surface of the copper foil, for example, by screen printing, so as to have a predetermined shape and a thickness in an approximate range of 50 μm to 100 μm. The positive electrode active material layer paste and the negative electrode active material layer paste are dried at 80° C. or more and 130° C. or less. Thus, the positive electrode active material layer is formed on the positive electrode current collector, and the negative electrode active material layer is formed on the negative electrode current collector. The positive electrode active material layer and the negative electrode active material layer each have a thickness of 30 μm or more and 60 μm or less.

Subsequently, the above glass powder is dispersed in an organic solvent or the like to produce a solid electrolyte layer paste. The above solid electrolyte layer paste is printed on each of the positive electrode and the negative electrode with a metal mask so as to have a thickness of, for example, about 100 μm. Thereafter, the positive electrode and the negative electrode, on which the solid electrolyte layer paste has been printed, are dried at 80° C. or more and 130° C. or less.

Subsequently, the solid electrolyte printed on the positive electrode and the solid electrolyte printed on the negative electrode are laminated so as to be in contact with each other and oppose to each other.

Subsequently, the laminate thus obtained is pressurized with a press die. Specifically, an elastic sheet having a thickness of 70 μm and an elastic modulus of about 5×10⁶ Pa is inserted between the laminate and the press die plate, that is, between the upper surface of the current collector of the laminate and the press die plate. According to this configuration, a pressure is applied to the laminate through the elastic sheet. Thereafter, the laminate is pressurized for 90 seconds while the press die is heated to at a pressure of 300 MPa. Thus, the battery element 100 is obtained.

The two battery elements 100 are prepared. On the surface of the negative electrode current collector of one of the battery elements 100, a thermosetting electrically conductive paste containing silver particles is printed by screen printing so as to have a thickness of about 30 μm. Then, the negative electrode current collector of the one battery element 100 and the positive electrode current collector of the other battery element 100 are disposed to be joined to each other with the electrically conductive paste, and are pressure-bonded. Thereafter, the battery elements 100 are allowed to stand with a pressure of, for example, about 1 kg/cm² applied, and subjected to a thermal curing process. The curing temperature is, for example, in an approximate range of 100° C. to 300° C. The curing time is, for example, 60 minutes. After the thermal curing process, the battery elements 100 are cooled to room temperature. Thus, the battery element 600 in which the two battery elements 100 are connected in series is obtained.

Subsequently, the two lead terminals 300a and 300b are prepared. The lead terminals are each, for example, formed of SUS having a thickness of 300 μm. With a silver-based electrically conductive resin, one lead terminal (e.g., the lead terminal 300a) is joined to the principal surface of the positive electrode current collector of the battery element 600, and the other lead terminal (e.g., the lead terminal 300b) is joined to the principal surface of the negative electrode current collector of the battery element 600, and the resin is subjected to a thermal curing process. The curing temperature is equal to or lower than the melting point of the solder material, and is, for example, 150° C. or more and 200° C. or less. The curing time is, for example, 1 hour or more and 2 hours or less. Thus, the lead terminals are joined to the battery element 600. Here, portions, of the lead terminals, that are to be enclosed with the insulating member 200 are plated in advance with Sn-based solder (e.g., with a thickness of 3 μm to 7 μm) serving as the first solder material. At this time, portions, of the lead terminals, that are to be joined to the battery element 600 may not be plated with solder.

The lead terminals are subjected to a bending process so as to have portions along the side surface of the battery element 600. Furthermore, for example, at a position about half the thickness of the battery element 600, the lead terminals are subjected to a bending process again. Thus, crank-shaped bent portions are formed in the lead terminals.

Subsequently, in a die, a thermosetting epoxy resin is put, and the battery element 600 to which the lead terminal is connected is immersed at a predetermined position for housing. Thereafter, the epoxy resin is cured at 180° C. to 210° C. for 1 hour to 2 hours. After the curing, exposed portions of the lead terminals exposed from the epoxy resin are subjected to a bending process, and a heat treatment is performed at a temperature equal to or higher than the melting point of the first solder material, for example, at 260° C., for 1 minute to 5 minutes. Thus, the battery 1300 is obtained. The heat treatment at a temperature equal to or higher than the melting point of the first solder material may be performed simultaneously with the mounting.

The method and order of forming the battery are not limited to the above examples.

The above manufacturing method shows the example in which, in manufacturing the battery element 100 and the battery element 600, printing is used to apply the positive electrode active material layer paste, the negative electrode active material layer paste, the solid electrolyte layer paste, and the electrically conductive paste. However, the printing method is not limited to this. The printing method may be, for example, a doctor blade method, a calendering method, a spin coating method, a dip coating method, an inkjet method, an offset method, a die coating method, or a spray method.

While the battery of the present disclosure has been described on the basis of the embodiments, the present disclosure is not limited to the embodiments. Various modifications of the embodiments conceivable by those skilled in the art and other embodiments achieved by combining some of the constituent elements of the embodiments also fall within the scope of the present disclosure without departing from the spirit of the present disclosure.

### INDUSTRIAL APPLICABILITY

The battery according to the present disclosure can be used, for example, as a secondary battery such as an all-solid-state battery for use in various electronic devices, automobiles, and the like.

What is claimed is:

1. A battery comprising:
a battery element, the battery element including a first electrode, a solid electrolyte layer, and a second electrode;
an insulating member;
a lead terminal; and
a first solder material, wherein
the insulating member encloses the battery element and the first solder material,
the lead terminal is electrically connected to the battery element, and
the first solder material is positioned between the insulating member and the lead terminal.

2. The battery according to claim 1, wherein
the first solder material is in a form of an island.

3. The battery according to claim 1, wherein
the first solder material includes a solder film provided on a surface of the lead terminal.

4. The battery according to claim 3, wherein
the solder film is a solder plating film.

5. The battery according to claim 1, wherein
the first solder material closes at least a portion of gaps between the insulating member and the lead terminal.

6. The battery according to claim 1, wherein
the lead terminal has a bent portion inside the insulating member.

7. The battery according to claim 6, wherein
the lead terminal is connected to a principal surface of the first electrode or a principal surface of the second electrode, and
the bent portion includes a crank-shaped bent portion, the crank-shaped being bent so that the lead terminal is bent from the principal surface of the first electrode or the principal surface of the second electrode toward a direction along a side surface of the battery element and is bent to extend toward an outside of the insulating member.

8. The battery according to claim 6, wherein
the first solder material includes a solder material in contact with the bent portion.

9. The battery according to claim 1, wherein
the lead terminal has an outside portion, the outside portion being positioned outside an outer periphery of the battery element in plan view, and
the first solder material is present between the outside portion and the insulating member.

10. The battery according to claim 1, wherein
the insulating member includes an epoxy resin.

11. The battery according to claim 1 further comprising
a sealing material, wherein
the sealing material is positioned between the insulating member and the lead terminal.

12. The battery according to claim 1 further comprising
a water-repellent material, wherein
the water-repellent material is in contact with the lead terminal.

13. The battery according to claim 1 further comprising
a fluxing material, wherein
the fluxing material is positioned between the insulating member and the first solder material.

14. The battery according to claim 1 further comprising
a second solder material, wherein
the second solder material coats at least a portion of a surface of an exposed portion of the lead terminal, the exposed portion being exposed from the insulating member.

15. A method for manufacturing a battery, the method comprising:
connecting a lead terminal to a battery element, the battery element including a first electrode, a solid electrolyte layer, and a second electrode;
enclosing the battery element with an insulating member; and
heating the lead terminal, wherein
the lead terminal includes a first solder material,
the first solder material is enclosed with the insulating member, and is positioned between the lead terminal and the insulating member, and
in the heating the lead terminal, the lead terminal is heated at a temperature equal to or higher than a melting point of the first solder material.
